(19) United States
(12) Patent Application Publication
(10) Pub. No.: US 2013/0311237 A1
(43) Pub. Date: Nov. 21, 2013

(54) REAL-TIME COMPUTER IMPLEMENTED METHOD OF CONSUMER SATISFACTION DETERMINATION FOR RETAIL BUSINESS

(71) Applicant: Karl Pischke, Drayton Valley (CA)

(72) Inventor: Karl Pischke, Drayton Valley (CA)

(21) Appl. No.: 13/841,289

(22) Filed: Mar. 15, 2013

Related U.S. Application Data
(60) Provisional application No. 61/647,620, filed on May 16, 2012.

(30) Foreign Application Priority Data
Jun. 7, 2012 (CA) 2779665

(51) Int. Cl. G06Q 30/02

(52) U.S. Cl. CPC G06Q 30/0203
USPC 705/7.32

(57) ABSTRACT

A real-time computer implemented method of customer satisfaction determination for retail business. A server computer is provided that powers a website on the world wide web. A web portal is provided that is accessible to members of the public through the world wide web, the web portal providing access that allows any individual member of the public to provide consumer feedback regarding their recent retail experience with a number of feedback options without having to identify themselves.

### FIELD

This relates to a method of determining consumer satisfaction in real-time for retail businesses.

### BACKGROUND

There are businesses that provide a consumer feedback template accessible through their webpage on the world wide web. These consumer feedback mechanisms typically require a lot of personal information to be provided. This personal information is sometimes abused, resulting in the consumer being placed on the businesses mailing list for advertisements. Some businesses offer store credits or lottery oriented programs for persons to complete surveys and provide feedback. However, when consumers are vying for a reward, they are inclined to be more positive in their comments believing that they would be less likely receive rewards if their comment were negative. Consumer feedback which is posted, if any, is subjected to a screening process giving an artificial indication of consumer satisfaction. Negative consumer feedback is generally not posted.

### SUMMARY

There is provided a real-time computer implemented method of customer satisfaction determination for retail business. A server computer is provided that powers a website on the world wide web. A web portal is provided that is accessible to members of the public through the world wide web, the web portal providing access that allows any individual member of the public to provide consumer feedback regarding their recent retail experience with a number of feedback options without having to identify themselves.

One feedback option includes a rating system, the rating being accompanied by a posting providing written justification in the form of a positive textual comment for a positive rating or a negative textual comment for a negative rating.

Another feedback option is to provide a contact name and request that the consumer feedback be passed along to the individual business.

The individual member of the public requesting that his or her consumer feedback be passed along to the business has the option of providing contact information to facilitate future communication from the business.

Further beneficial results may be seen when an individual retail business who receives a negative textual comment has an opportunity to address the negative textual comment and thereby maintain a positive rating.

Still further beneficial results may be seen when individual members of the public who join are provided with access to determine whether individual retail businesses have been assigned positive ratings or negative ratings. Individual members also have the opportunity to review positive textual comments and negative textual comments made by other individual members of the public.

Still further beneficial results may be seen when individual retail businesses that join and maintain a positive rating are able to pay for advertisements, discount programs, or coupons programs to entice members of the public to patronize their individual retail businesses.

### BRIEF DESCRIPTION OF THE DRAWINGS

These and other features will become more apparent from the following description in which reference is made to the appended drawing, the drawing is for the purpose of illustration only and is not intended to be in any way limiting, wherein:

FIG. 1 is a flow chart of a method for rating retail business performance

### DETAILED DESCRIPTION

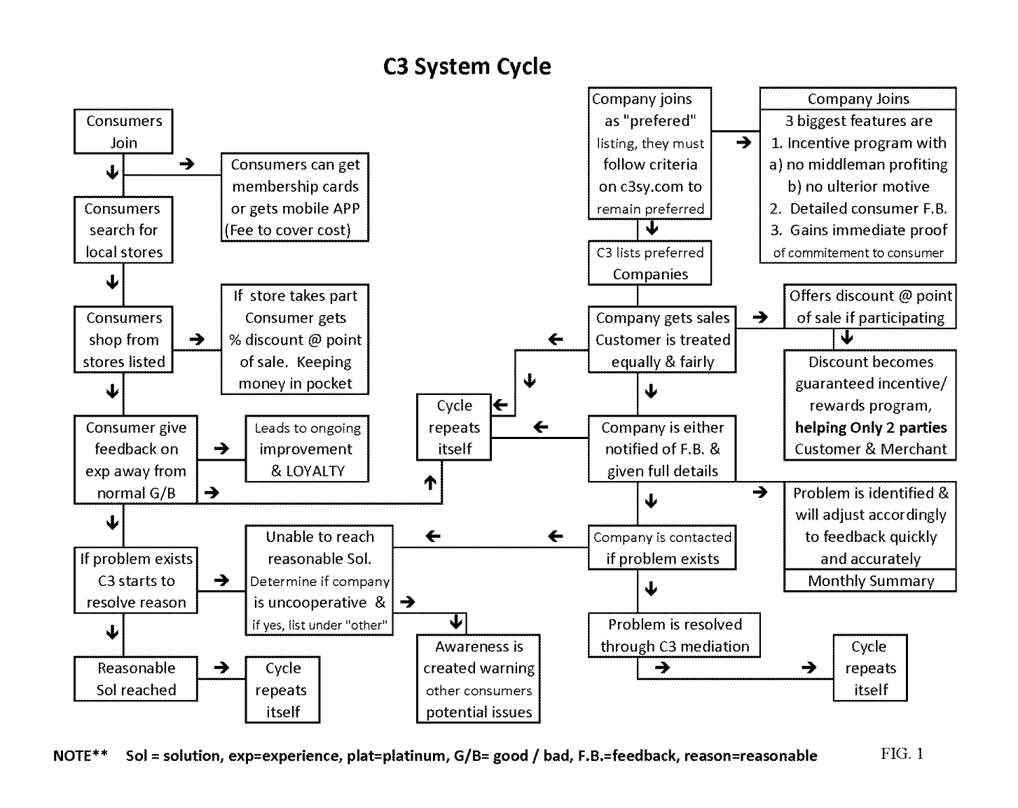

A computer implemented method of rating retail business performance generally identified by reference numeral 10 will now be described with reference to FIG. 1.

Referring to FIG. 1, a computer implemented method of rating retail business performance includes a server computer with a rating system that assigns retail businesses a consumer rating based upon public input. A web portal is provided that is accessible to the public through the world wide web. The web portal provides access to individual members of the public to assign a consumer rating using the rating system to any retail business in view of their recent retail experience, without having to identify themselves. Each consumer rating by each individual member of the public is accompanied by written justification in the form of positive textual comment for a positive rating or a negative textual comment for a negative rating. The individual member of the public has the option of providing contact information to facilitate future communication between the individual member and the retail business.

When a negative textual comment is received, the individual retail business is provided with an opportunity to address the negative textual comment and thereby maintain a positive rating. An otherwise negative textual comment can be turned into a positive for the business by demonstrating responsiveness by the retail business in resolving the consumer complaint.

Individual members of the public who join are provided with access to the web portal to determine whether individual retail businesses have been assigned positive ratings or negative ratings. Members are also given the opportunity to review either the positive textual comment or the negative textual comment of other individual members of the public.

Individual retail businesses that join and maintain a positive rating are able to pay for advertisements, discount programs or coupons programs to entice member of the public to patronize their individual retail businesses.

The rating system has two sides to it, the consumer side and the company side. Local geographical communities are created online which matches consumers who want better customer service with companies who provide better customer services. Consumers may search the rating system to seek companies with a positive consumer rating and a positive responsiveness rating indicating such companies are committed to customer satisfaction, as opposed to those companies that are rated as unreasonable. When customers shop from a participating company, they will have the opportunity to submit a form indicating their experiences within the store, both good and bad. The customer will have the opportunity to provide information that allows the company they have reviewed to respond to them, however this information is not required. A review may be completed to simply inform other potential customers of their experiences. The customer may also have a problem of some sort which can be resolved with assistance from the rating system owner. Companies that are open to resolving the problem amicably are rated as reasonable for their responsiveness rating while companies unwilling to help in resolution will be deemed unreasonable. Companies that are inserted into the rating system receive detailed information regarding consumer feedback unless the company has been previously deemed unreasonable. Both consumers and companies may benefit from the rating system and companies with good ratings will likely increase their number of customers through use of this system.

The computer implemented method of rating retail business performance creates awareness of the companies while being affiliated with better customer service by networking consumers and companies within a community. The companies are held accountable for the services they provide as customers provide feedback on their experiences for other potential customers to read. Consumer and company information is not required for the method to work. While companies cannot control complaints by customers, they can control their responsiveness to those complaints in order to maintain a positive responsiveness rating.

In at least one embodiment, the options that may be given to consumers providing feedback are as follows:

1. provide your name (optional);

2. provide your email address (optional);

3. provide your feedback submission;

4. posting of the feedback submission (optional);

5. pass name along to company with submission (optional—must supply a name); and

6. be contact after (optional—requires an email address).

In one implementation, Consumer feedback received was generally of three types: 1) positive, 2) negative, and 3) suggestions for improvement. The experience gained from having the consumer feedback website operational for a number of months indicates that 81.7% of persons providing feedback were prepared to give personal information to management of the consumer feedback website, while the remainder of consumer feedback was anonymous. Of the persons providing consumer feedback, 52.5% of the persons wished to have their consumer feedback submission posted for others to read, the remainder provided consumer feedback requesting that it not be posted. Of the persons providing consumer feedback, 54.6% provided their name and agreed to have their feedback submission passed along to the business. However, of these only 42.7% provided an email address to enable the company to contact them for the purpose of having their concerns addressed.

The consumer feedback website is independent of the business and provides a more true and accurate indication of consumer satisfaction. It also gives feedback in a timely manner, which may disclose improvements in service or deterioration in service of existing businesses. If a consultant were hired to perform an analysis to provide an analagous measurement, such analysis would be expensive and would only reflect service levels and customer satisfaction as a “snap shot” as they existed at a specific time. It is to be noted that the selections by the consumer from the six options outlined above differed with the nature of their concerns as reflected in their feedback. When the feedback was positive, they tended to permit their name to be passed along and saw no need for follow up contact. When there were suggestions for improvement, they tended to permit their name to be passed along sometimes with and sometimes without an email for future contact. When the feedback was negative, they were more inclined to want the information posted. Sometimes the problems experienced were incapable of being addressed after the fact. In such cases, there was no name or email address given. In other situations, the problem was on going and the name and email address were given in the expectation that a solution could be worked out or facilitated through a mediation triggered by the contract by the feedback website.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples, but should be given the broadest interpretation consistent with the description as a whole.

What is claimed is:

1. A real-time computer implemented method of customer satisfaction determination for retail business, comprising:
providing a server computer that powers a website on the world wide web; and
providing a web portal accessible to members of the public through the world wide web, the web portal providing access that allows any individual member of the public to provide consumer feedback regarding their recent retail experience with a number of feedback options without having to identify themselves.

2. The method of claim 1, wherein each individual member of the public has a feedback option that includes a rating system, the rating being accompanied by a posting providing written justification in the form of a positive textual comment for a positive rating or a negative textual comment for a negative rating.

3. The method of claim 1, wherein each individual member of the public has an option of providing a contact name and requesting that the consumer feedback be passed along to the individual business.

4. The method of claim 3, wherein each individual member of the public requesting that his or her consumer feedback be passed along to the business has the option of providing contact information to facilitate future communication from the business.

5. The method of claim 3, wherein when a negative textual comment is received, an individual retail business to which the negative textual comment pertains is provided with an opportunity to address the negative textual comment and thereby maintain a positive rating.

6. The method of claim 2, wherein individual members of the public who join are provided with access to determine whether individual retail businesses having been assigned positive ratings or negative ratings, along with the opportunity to review either the positive textual comment or the negative textual comment of other individual members of the public.

7. The method of claim 6, wherein individual retail businesses who join and maintain a positive rating are able to pay for advertisements, discount programs, or coupons programs, to entice the members of the public to patronize their individual retail businesses.
